(19) United States
(12) Patent Application Publication
(10) Pub. No.: US 2006/0124553 A1
(43) Pub. Date: Jun. 15, 2006

(54) Method of preventing or reducing aluminosilicate scale in high level nuclear wastes

(76) Inventors: Matthew Lee Taylor, New York, NY (US); Haunn-Lin Tony Chen, Darien, CT (US); Donald P. Spitzer, Stamford, CT (US); Howard I. Heitner, Stamford, CT (US)

Correspondence Address: CYTEC INDUSTRIES INC., 1937 WEST MAIN STREET, P.O. BOX 60, STAMFORD, CT, 06904-0060, US

(21) Appl. No.: 11/197,237

(22) Filed: Aug. 4, 2005

Related U.S. Application Data
(63) Continuation-in-part of application No. 10/780,302, filed on Feb. 17, 2004.
Application No. 10/780,302 is a division of application No. 10/201,209, filed on Jul. 22, 2002, now Pat. No. 6,814,873.
(60) Provisional application No. 60/651,347, filed on Feb. 9, 2005.

(51) Int. Cl. C02F 1/00

(52) U.S. Cl. 210/698

(57) ABSTRACT

Materials and a process are provided whereby polymers with the pendant group or end group containing —Si(OR″)₃ (where R″ is H, an alkyl group, Na, K, or NH₄) are used to control aluminosilicate scaling in a nuclear waste process. When materials of the present invention are added to the nuclear waste liquor, they reduce and even completely prevent formation of aluminosilicate scale on equipment surfaces such as evaporator walls and heating surfaces. The present materials are effective at treatment concentrations that make them economically practical.

### SUMMARY OF THE INVENTION

The invention describes materials and processes for the prevention or inhibition of formation of scales in nuclear waste treatment facilities.

### BACKGROUND OF THE INVENTION

High Level Nuclear Waste (HLNW) facilities process radioactive-rich solid and liquid wastes in order to minimize waste volume and immobilize the hazardous material for long term storage. HLNW treatment is currently performed via two processes; one process is performed under acidic conditions and one under alkaline conditions. Under alkaline processing conditions, sodium aluminosilicate scale growth is a significant problem during the pretreatment stage, prior to waste vitrification.

In the alkaline process, 4M NaOH is used to dissolve any aluminum species present in the stored radioactive waste slurry, which otherwise would lead to viscosity problems during the vitrification process and would result in higher volumes of HLNW to be treated. The alkaline waste is then ‘pretreated’ in order to decrease the volume of material and to separate High Level (or activity) Nuclear Waste (HLNW) from Low Level (or activity) Nuclear Waste (LLNW). Within the pretreatment facility, the waste is evaporated, filtered, ion exchanged and further evaporated. During evaporation, aluminosilicate scales can form on the surfaces of the evaporator walls and heating surfaces. Furthermore, transfer pipes can also become blocked due the buildup of these scales and precipitates necessitating closure for maintenance.

LLNW is the liquid portion of the tank waste and contains a relatively small amount of radioactivity in a large volume of waste liquor. HLNW is primarily the solids of the waste tank and contains the majority of the radioactivity in a relatively small volume of waste liquor. These solids are filtered out and the remaining soluble highly radioactive isotopes are removed by ion exchange units.

The pretreated wastes go to separate LLNW and HLNW vitrification facilities. Handling the wastes separately speeds up the treatment process as high volumes of LLNW can be processed faster than smaller volumes of HLNW.

In each of the separate facilities, HLNW or LLNW waste goes into a melter preparation vessel where silica and other glass-forming materials are added. Then the mixture is fed into one of two melters. The mixture is then heated to 2,100° F. by passing electricity though it (i.e. joule heating). The molten mixture is then poured into large stainless steel containers, cooled and moved into temporary storage until a permanent storage location is selected.

From the vitrification unit operation, a portion of the Si-containing glass-forming materials are recycled back into the evaporator unit (during pretreatment). The dissolved aluminum, in the form of sodium aluminate, and sodium silicate species react slowly in solution to form complex hydrated sodium aluminosilicate species. Among these species are families of amorphous aluminosilicates (aluminosilicate hydrogel), zeolites, sodalites, and cancrinites and hence the general name of ‘sodium aluminosilicates’ is preferred. These nuclear waste streams also contain high concentrations (up to 2M for each ion) of nitrate and nitrite ions, and very high concentrations (up to 16M in some sections of the tank) of OH⁻ ions. These factors greatly enhance the rate of formation of aluminosilicate scale. As a result, sodium aluminosilicate scale formed has a low solubility in the alkaline HLNW liquor.

Also, sodium aluminosilicate scale is considered to be an undesirable HLNW product due to the incorporation of radioactive lanthanides and actinides into the aluminosilicate scale cage structures and coprecipitation of sodium diuranate. (Peterson, R. A. and Pierce, R. A., (2000), Sodium diuranate and sodium aluminosilicate precipitation testing results, WSRC-TR-2000-00156, Westinghouse Savannah River Company, Aiken, S.C.). It is therefore, desirable for HLNW facilities to minimize the volume of HLNW's including those resulting from aluminosilicate scales. Thus, it can be seen that, sodium aluminosilicate scale growth has a significant negative economic and operational impact on the treatment of nuclear wastes.

Therefore, providing a solution to the sodium aluminosilicate scaling problem in the nuclear waste evaporators would provide the following benefits: (a) energy saving due to a reduction in the loss of energy across evaporators, (b) no acid and mechanical cleaning required, thus saving on acid and a reduction in the amount of LLNW generated, (c) increased safety due to a reduction in sodium diuranate (criticality issue), (d) an increase in throughput since a reduction in HLNW solids to LLNW results in more rapid processing and there would be less constriction in the pipes/transfer lines to reduce the flow see Mattigod, S. V., Hobbs, D. T., Parker, K. E. and McCready, D. E., (2004), Precipitation of scale-forming species during processing of high level wastes, Zachry, T. (Ed.) Environmental and waste management: Advancements through the environmental management science program, Symposia of papers presented before the Division of Environmental Chemistry American Chemical Society, pp. 430-432.; Wilmarth, W. R., Coleman, C. J., Hart, J. C. and Boyce, W. T., (2000), Characterization of Samples from the 242-16H evaporator wall, WSRC-TR-2000-00089, Westinghouse Savannah River Company, Aiken, S.C.)

Attempts to solve the aforementioned problems have lead to limited success see Wilmarth and coworkers (Wilmarth, W. R., Mills, J. T. and Dukes, V. H., (2005), Removal of silicon from high-level waste streams via ferric flocculation, Separation Sci. Technol., 40, 1-11. These authors have examined the use of ferric nitrate to remove Si from solution in the form of a ferric precipitate, in order to reduce or eliminate the formation of aluminosilicate scale. Although this approach has some merit, there is still the disposal of the high-level ferric precipitate to deal with and an additional filtration unit operation is required. Also, W. R. Wilmarth and J. T. Mills “Results of Aluminosilicate Inhibitor Testing”, WSRC-TR-2001-00230 have proposed using low molecular weight compounds as scale inhibitors for HLNW's but have found none to be satisfactory. Thus there is a need for an economical and effective method for reducing aluminosilicate scales in nuclear waste treatment streams.

Scale build up has also been known to be a problem in other industries. For example in boiler water systems where a number of treatments for reducing scale in boiler water systems have been proposed. In boiler water systems, pH is generally only 8 to 9 and dissolved salts are usually not present in concentrations more than about one to five grams/liter. Exemplary treatments for scale in boilers include siliconate polymers such as the copolymers of acrylic acid, 2-acrylamido-2-methylpropane sulfonic acid (AMPS), and 3-(trimethoxysilyl)propyl-methacrylate as disclosed by Mohnot (Journal of PPG Technology, 1 (1), (1995) 19-26). These polymers are reported to reduce the amount of silica gel adhering to the wall of polytetrafluoroethylene bottles in tests done with 645 ppm SiO₂ at pH 8.3 and 100° C., i.e., conditions approximating those in a boiler. A Japanese patent application (Kurita Water Ind. Ltd., 11-090488 (1999)) also deals with adhesion of silica-type scale in cooling water or boiler water systems. The compositions disclosed are vinyl silanol/vinyl alcohol copolymers, which may also contain, e.g., allyl alcohol or styrene. Tests are done in water that contained 200 mg/l silica at pH 9.0 and temperatures of 45-75° C. Use of the subject compounds reportedly led to less silica scale compared to an acrylic acid-AMPS copolymer.

In boilers the pH is generally quite mild, only 8 to 9 and dissolved salts are usually not present in concentrations more than about one to five grams/liter. Additionally, scales formed in boiler water systems consist of primarily amorphous silica, although other scales such as calcium carbonate, calcium phosphate, etc., are possible.

U.S. Pat. No. 6,814,873 describes a treatment for aluminosilicate scale for the Bayer process in which a liquor containing very high levels of aluminum ions is processed through heat exchanger to recovery energy values from the process. Also V. G. Kazakov, N. G. Potapov, and A. E. Bobrov, Tsvetnye Metally (1979) 43-44; V. G. Kazakov, N. G. Potapov, and A. E. Bobrov, Tsvetnye Metally (1979) 45-48 report reducing scaling in the Bayer process during the heating of aluminate solutions by using a siloxane polymer (a silicon-oxygen polymer with ethyl and —ONa groups attached to the silicones), i.e.,

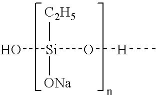

It was reported that at the relatively high concentrations of 50-100 mg/l, this polymer was effective in preventing decrease of the heat transfer coefficient of heat exchanger walls. Methods of altering the morphology of aluminosilicate scales in the Bayer process have been disclosed using either amines and related materials (U.S. Pat. No. 5,314,626 (1994)) or polyamines or acrylate-amide polymers (U.S. Pat. No. 5,415,782 (1995)). While these materials were shown to modify the morphology of the aluminosilicate particles, there were no examples of reduction in the amount of scaling. Additionally, treatment concentrations required were quite high, in the range of 50 to 10,000 parts per million. Also WO02070411 describes the use of copolymers containing isobutyl(meth)acrylate moieties for reducing scaling in the Bayer process. The patent application claimed that the acrylate polymer reduced scale formation. The examples disclosed showed that scale was not completely eliminated and that the mass of products precipitated were substantially the same as a control test in which no polymer was used.

Thus, there remains a need to provide an effective method for treating aluminosilicate scales found in nuclear waste streams.

### SUMMARY OF THE INVENTION

The present invention solves the aforementioned problems and others by providing materials and a process whereby polymers with the pendant group or end group containing —Si(OR″)₃ (where R″ is H, an alkyl group, Na, K, or NH₄) are used to reduce or eliminate aluminosilicate scaling in a HLNW evaporation process. When materials of the present invention are added to the nuclear waste process stream , they reduce and even completely prevent formation of aluminosilicate scale on the evaporator surfaces. Moreover, the present materials are effective at treatment concentrations that make them economically practical.

### DETAILED DESCRIPTION OF THE INVENTION

The present invention is directed to a process and materials for the reduction of aluminosilicate containing scale in the evaporation of nuclear waste streams. The process comprises the step of adding to the process stream an aluminosilicate containing scale inhibiting amount of a polymer having pendant thereto a group or end group containing —Si(OR″)₃ where R″═H, C1-C3 alkyl, aryl, Na, K or NH₄. The present inventors have found that the scale reducing or inhibiting properties of the polymer having a pendant group containing —Si(OR″)₃ where R″═H, C1-C3 alkyl, aryl, Na, K or NH₄, attached thereto is not dependant on the configuration and/or size of the polymer to which the group is attached. Therefore, any polymer, having the requisite group containing —Si(OR″)₃ where R″═H, C1-C3 alkyl, aryl, Na, K or NH₄ attached thereto should therefore be suitable for use in the present invention. The amount of —Si(OR″)₃ functionality present in the polymer will be an amount sufficient enough to achieve the desired results and can range from a little as 0.5 mole % of the total monomer groups present in the polymer to as much as 100 mole %. However it will be most economical to use the least amount necessary to yield the desired results. The polymers are preferably prepared initially as the silylether derivatives Polymer —Si(OR″)₃ where R″═C1-C3 alkyl, aryl, eg Polymer —Si(OCH₂CH₃)₃ or Polymer —Si(OCH₃)₃ The silylether derivatives may be added directly to the nuclear waste stream or they may hydrolyzed to the silanol derivatives to form polymers of the following generic structures, Polymer —Si(OH)₃ Polymer —Si(ONa)₃ Polymer —Si(OK)₃ and Polymer —Si(ONH₄)₃ before addition to the process stream. It is a convenient feature of this invention that any of these forms may be added to the process stream. The molecular weight of the polymer should be at least about 500 most preferably at least about 1000.

In a preferred embodiment, the group containing —Si(OR″))₃, where R″═H, C1-C3 alkyl, aryl, Na, K or NH₄ comprises a group according to -G-R—X—R′—Si(OR″)₃ where G=no group, NH, NR″ or O; R=no group, C═O, O, C1-C10 alkyl, or aryl; X=no group, NR, O, NH, amide, urethane, or urea; R′=no group, O, C1-C10 alkyl, or aryl; and R″═H, C1-C3 alkyl, aryl, Na, K or NH₄.

In one embodiment, the group is —NH—R—X—R′—Si(OR″)₃, where R=no group, O, C1-C10 alkyl, or aryl; X═O, NH, an amide, urethane, or urea; R′=no group, O, C1-C10 alkyl, or aryl; and R″═H, C1-C3,alkyl, aryl, Na, K or NH₄.

In another embodiment the polymer to which the group is pendant can comprise at least one nitrogen to which the pendant group is attached. Exemplary polymers comprising at least one nitrogen to which the pendant group is attached include, but are not limited to, a polymer according to the following formula: 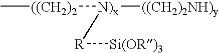
where x=0.1-100%, y=99.9-0%; and R=no group, C1-C10 alkyl, aryl, or —COX—R′—, where X═O or NH and R′=no group, C1-C10 alkyl or aryl; and R″═H, C1-C3 alkyl, aryl, Na, K or NH₄; wherein polymers according to the formula: 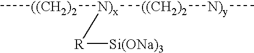
where x=0.5-20%, y=99.5-80% and R═C2-C6 are preferred, and wherein polymers according to the formula: 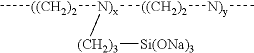
where x=0.5-20%, y=99.5-80% are specific examples.

In another embodiment the polymer having pendant thereto a group or end group containing —Si(OR″)₃ is derived from an unsaturated polymerizable monomer containing the group —Si(OR″)₃ where R″═H, C1-C10 alkyl, aryl, Na, K or NH₄ and is optionally copolymerized with one or more additional polymerizable monomer(s). Examples of such additional polymerizable monomers include but are not limited to vinylpyrrolidone, (meth)acrylamide, N-substituted acrylamides such as N-alkylacrylamides or acrylamidomethylpropanesulfonic acid, (meth)acrylic acid and it's salts or esters, maleimides, vinyl acetate, acrylonitrile, and styrene. Particularly preferred unsaturated polymerizable monomers containing —Si(OR″)₃ groups are monomers of formula V and VI.

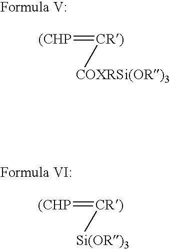

where P═H, C1-C3 alkyl, —CO₂R″, —CONHR
R═C1-C10 alkyl, aryl,
R′═H, C1-3 alkyl, or aryl
X═O, NH, or NR
R″═H, C1-C3 alkyl, aryl, Na, K or NH₄.

Examples of such polymers include homo- and copolymers of trialkoxyvinylsilanes such as CH₂═CHSi(OCH₂CH₃)₃ and monomers of the formula VII: 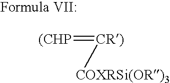
where P═H, R═—CH₂CH₂CH₂—, R′═H , X═NH and R″═H, C1-C3 alkyl, aryl, Na, K or NH₄.

Monomers of this type may be copolymerized with any other polymerizable monomers such as those described above. Particularly preferred copolymerizable monomers include vinylpyrrolidone, (meth)acrylamide, N-substituted (meth)acrylamides, (meth)acrylic acid and it's salts or esters and maleimides. Particularly preferred are N-substituted acrylamides containing 4-20 carbon atoms such as N-methylacrylamide, N,N-dimethylacrylamide, N-ethylacrylamide N-propylacrylamide, N-butylacrylamide, N-amylacrylamide, N-hexylacrylamide, N-penylacrylamide, N-octylacrylamide.

In a preferred embodiment a polymer according to the formula: 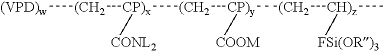
where w=0-99% , x=1-99%, y=1-99% , z=0.5-20% and M=H, Na, K, NH₄; and R″═H, C1-10 alkyl, aryl, Na, K or NH₄; P═H or CH₃, L=H, or C1-C10 alkyl, aryl or aralkyl, F=-G-R—X—R′—Si(OR″)₃ wherein G=no group, NH, NR″ or O; R=no group, C═O, O, C1-C10 alkyl, or aryl; X=no group, NR, O, NH, amide, urethane, or urea; R′=no group, O, C1-C10 alkyl, or aryl; and R″═H, C1-C3 alkyl, aryl, Na, K or NH₄ and VPD is a moeity derived from substituted or unsubstituted vinylpyrrolidone monomer. Examplary polymers are homo- or copolymers of one or more comonomers of formulae VII: 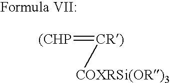
where P═H, R═—CH₂CH₂CH₂—, R′═H, X═NH and R″═H, C1-C3 alkyl, aryl, Na, K or NH₄ wherein polymers according to the following formula: 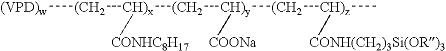
wherein w=0-90%, x=0-50%, Y=0-90%, Z=2-50 mole % are specific examples.

In another embodiment, a polymer according to the formula: 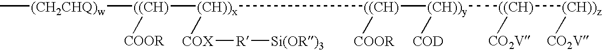
where w=1-99.9 %, x=0.1-50%, y=0-50%, z=0-50%; and Q=C1-C10 alkyl, aryl, amide, acrylate, ether, COXR where X═O or NH and R═H, Na, K, NH₄, C1-C10 alkyl or aryl, or any other substituent; X═NH, NP where P═C1-C3 alkyl or aryl, or O; R′═C1-10 alkyl, or aryl; V″═H, C1-C3 alkyl, aryl, Na, K or NH₄ or forms an anhydride ring; R″═H, C1-C3 alkyl, aryl, Na, K or NH₄; and D=NR1₂ or OR1 wherein R1=H, C1-C20 alkyl, C1-C20 alkenyl or aryl, with the proviso that all R, R″, V″ and R1 groups do not have to be the same, is used, and wherein polymers according to the formulae: 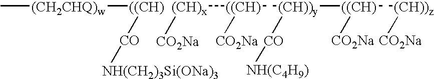
where w=1-99.9%, x=0.1-50%, y=0-50%, z=0-50%; and Q is phenyl, and: 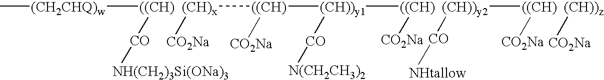
where w=1-99.9%, x=0.1-50%, y1+Y2=0-50%, y1 and y2=0-50% z=0-50%; and Q is phenyl are specific examples.

In another embodiment a polymer according to the formula:
A-O—(CH₂CH₂O)ₓ(CH₂CH (CH₃)O)_{y}(CH₂CH₂O)_{Z}—O—B

where x=5-100% (as mole %), y and z=0-100% and at least one A and/or B unit is a group containing the the group —Si(OR″)₃, where R″═H, C1-C3 alkyl, aryl, Na, K or NH₄, is used. Exemplary such polymers include; A-O—(CH₂CH₂O)ₓ(CH₂CH(CH₃)O)_{y}(CH₂CH₂O)_{z}—O—B in which A and/or B═R—Si(OR″)₃, and x=5-50%, y=5-95% and z=0-50% ie a copolymer of ethylene oxide and propylene oxide substituted with —Si(OR″)₃ groups, and A-O—(CH₂CH₂O)ₓ(CH₂CH(CH₃)O)_{y}(CH₂CH₂O)_{z}—O—B in which A and/or B═R—Si(OR″)₃, x=100%, y=0% and z=0% ie a homopolymer of polyethylene oxide substituted with R—Si(OR″)₃ groups is used.

In another embodiment a polymer prepared from a polysaccharide or polysaccharide derivative is used. Any polysaccharide to which the pendant —Si(OR″)₃ groups can be attached may be employed. Preferably the polysaccharide should be soluble in the nuclear waste liquor. Polysaccharides useful in this invention include but are not limited to cellulose and it's derivatives, such as hydroxyethylcellulose, hydroxypropylcellulose, methylcellulose, hydroxybutylcellulose, carboxymethylcellulose, starch and starch derivatives such as cationic starch, guar, dextran, dextrins, xanthan, agar, carrageenan and the like. Particularly preferred are starch and cellulose derivatives wherein the reaction product of hydroxyethylcellulose with 3-glycidoxypropyltrimethoxysilane is a specific example.

The polymers used in the invention can be made in a variety of ways. For example, they can be made by polymerizing a monomer containing the group —Si(OR″)₃, where R″═H, C1-C3 alkyl, aryl, Na, K or NH₄, such as for example a silane monomer, or copolymerizing such a monomer with one or more co-monomers. Suitable silane monomers for use in the present invention include, but are not limited to vinyltriethoxysilane, vinyltrimethoxysilane, allyltriethoxysilane, butenyltriethoxysilane, gamma-N-acrylamidopropyltriethoxysilane, p-triethoxysilylstyrene, 2-(methyltrimethoxysilyl)acrylic acid, 2-(methyltrimethoxysilyl)-1,4 butadiene, N-triethoxysilylpropyl-maleimide and other reaction products of maleic anhydride and other unsaturated anhydrides with amino compounds containing the —Si(OR″)₃ group. These monomers can be hydrolyzed by aqueous base, either before or after polymerization. Suitable co-monomers for use in the present invention include, but are not limited to, vinyl acetate, acrylonitrile, styrene, (meth)acrylic acid and its esters or salts, (meth)acrylamide and substituted acrylamides such as acrylamidomethylpropanesulfonic acid, N-methylacrylamide, N,N-dimethylacrylamide, N-ethylacrylamide N-propylacrylamide, N-butylacrylamide, N-amylacrylamide, N-hexylacrylamide, N-penylacrylamide, N-octylacrylamide. The copolymers can also be graft copolymers such as polyacrylic acid-g-poly(vinyltriethoxysilane) and poly(vinyl acetate-co-crotonic acid)-g-poly(vinyltriethoxysilane). These polymers can be made in a variety of solvents. Solvents suitable for such use include, but are not limited to, acetone, tetrahydrofuran, toluene, xylene, etc. In some cases the polymer is soluble in the reaction solvent and is recovered by stripping off the solvent. Alternatively, if the polymer is not soluble in the reaction solvent, the product is recovered by filtration. Suitable initiators for use in the present invention include, but are not limited to, 2,2′azobis(2,4-dimethylvaleronitrile) and 2,2-azobisisobutyronitrile, benzoyl peroxide, and cumene hydroperoxide.

In another embodiment of the present invention, polymers useful in the invention can be made by reacting a compound containing a —Si(OR″)₃ group as well as a reactive group that reacts with either a pendant group or backbone atom of an existing polymer. For example, polyamines and polysaccharides can be reacted with a variety of compounds containing —Si(OR″)₃ groups to give polymers which can be used for the invention. Suitable reactive groups include, but are not limited to an alkyl halide group, such as for example, chloropropyl, bromoethyl, chloromethyl, and bromoundecyl. The compound containing —Si(OR″)₃, can contain an epoxy functionality such as glycidoxypropyl, 1,2-epoxyamyl, 1,2-epoxydecyl or 3,4-epoxycyclohexylethyl. 3-glycidoxypropyltrimethoxysilane is a particularly preferred compound.

The reactive group can also be a combination of a hydroxyl group and a halide, such as 3-chloro-2-hydroxypropyl. The reactive moiety can also contain an isocyanate group, such as isocyanatopropyl, or isocyanatomethyl that react to form a urea linkage. In addition, silanes containing anhydride groups, such as triethoxysilylpropylsuccinic anhydride are suitable for use in making the polymers for the present invention. The reactions can be carried out either neat or in a suitable solvent. In addition, other functional groups such as alkyl groups can be added by reacting other amino groups or nitrogen atoms on the polymer with alkyl halides, epoxides or isocyanates. The polyamines can be made by a variety of methods. They can be made by a ring opening polymerization of aziridine or similar compounds. They also can be made by condensation reactions of amines such as ammonia, methylamine, dimethylamine, ethylenediamine etc. with reactive compounds such as 1,2-dichloroethane, epichlorohydrin, epibromohydrin and similar compounds.

Polymers containing anhydride groups can be reacted with a variety of compounds containing —Si(OR″)₃ to make polymers suitable for use in the present invention. Suitable anhydride containing polymers include copolymers of maleic anhydride with ethylenically unsaturated monomers such as styrene, ethylene, alpha olefins such as octadecene, meth(acrylamide), (meth)acrylic acid, acrylate esters such as methyl (meth)acrylate, ethyl (meth)acrylate, butyl acrylate and methylvinylether. The polymer can also be a graft copolymer such as poly(1,4-butadiene)-g-maleic anhydride or polyethylene-g-maleic anhydride and the like. Other suitable anhydride monomers include, but are not limited to, itaconic and citraconic anhydrides. Suitable reactive silane compounds include, but are not limited to γ-aminopropyltriethoxysilane, bis(gamma-triethoxysilylpropyl)amine, N-phenyl-gamma aminopropyltriethoxysilane, p-aminophenyltriethoxysilane, 3-(m-aminophenoxypropyl)-trimethoxysilane, and gamma-aminobutyltriethoxylsilane. Other functional groups can be added to the polymer by reacting it with amines, alcohols and other compounds. In a preferred polymer for use in the present invention, maleic anhydride is the anhydride and the co-monomer is styrene. A preferred silane is gamma-aminopropyltriethoxysilane. It is also advantageous to react some of the anhydride groups with another amine such as diethylamine.

The same type of amino compound containing an —Si(OR″)₃ group can be reacted with polymers containing a pendant isocyanate group, such as copolymers of for example, isopropenyldimethylbenzylisocyanate and vinyl isocyanate, with co-monomers including, but not limited to, vinyl acetate, styrene, acrylic acid, and acrylamide. These polymers can also be reacted with other compounds such as amines to enhance performance.

Isocyanate functional compounds with an —Si(OR″)₃ group such as gamma-isocyanatopropyltrimethoxysilane can also be reacted with polymers containing hydroxyl groups such as hydrolyzed poly(vinyl acetate) and copolymers of vinyl acetate with other monomers. Other hydroxyl containing polymers suitable for use include, but are not limited to, polysaccharides and polymers containing N-methylolacrylamide.

In the present process, the amount of polymer added to the process stream can depend on the composition of the Nuclear waste liquor involved and generally all that is required is an aluminosilicate containing scale inhibiting amount thereof. In general the polymer is preferably added to the process stream in economically and practically favorable concentrations. A preferred concentration is one that is greater than about 0 ppm to about 300 ppm, more preferably in a concentration that is greater than about 0 ppm to about 50 ppm and most preferably the polymer is added to the process stream in a concentration that is greater than about 0 ppm to about 10 ppm.

The polymer can be added directly to the evaporator in which the formation of aluminosilicate containing scale is to be inhibited. It is preferred, however to add the polymer to a charge stream or recycle stream or liquor leading to the evaporator. While the polymer can be added to the nuclear waste process stream at any time during the process, it is preferable to add it at any convenient point in the nuclear waste process before or during application of heat. Usually, the polymer is added immediately before the evaporator.

### EXAMPLES

### Comparative Example A

Preparation of the reaction product of styrene/maleic anhydride copolymer with butylamine (Comparative Polymer A) is as follows: 10.0 g of dry styrene/maleic anhydride copolymer (SMA), with a mole ratio of styrene to maleic anhydride of about 1.1 and M_{w} about 16,000, is suspended in 100 ml of toluene. A solution of 1.72 g of butylamine in 10 ml of toluene is added at ambient temperature. The mixture is refluxed for 3 hr. The solid product is filtered off, washed, and dried. This gives a polymer containing 53 mole % styrene, 24 mole % N-butyl half amide from maleic anhydride, and 23 mole % maleic anhydride.

### Comparative Example B

Preparation of the reaction product of SMA with tallow amine and diethylamine (Comparative Polymer B) is as follows: 100.0 g of dry SMA, with a mole ratio of styrene to maleic anhydride of about 1.1 and M_{w} about 16,000, is suspended in 941.7 g of toluene. A solution of 25.2 g tallow amine and 27.5 g diethylamine in 35.2 g toluene is added at ambient temperature and the mixture is then refluxed for 30 min. The resulting toluene slurry is cooled to room temperature and then added with mixing to about 700 ml of 2% aqueous caustic. The toluene layer is separated and the residual toluene in the aqueous phase is removed by distillation. The aqueous solution is further purified by ultrafiltration using a 0.2 μm hydrophilic polyethersulfone filter and then freeze dried to obtain the dry polymer. This gives a polymer containing 53 mole % styrene, 38 mole % N-diethyl half amide from maleic anhydride, and 9 mole % N-tallow half amide from maleic anhydride.

### Comparative Example C

Preparation of a copolymer of N-tert-octylacrylamide and acrylic acid (Comparative Polymer C) is as follows: 2.81 g Acrylic acid, 2.52 g N-tert-octylacrylamide, and 0.14 g 2-mercaptoethanol are dissolved in 12.5 g DMF and 13.87 g dioxane and purged with nitrogen. The mixture is heated to 75° C. and 0.16 g 2,2′-azobis(2,4-dimethylvaleronitrile) in 3 g dioxane is added. After 6 hr at 75° C., the mixture is cooled, giving the desired polymer in solution. This gives a polymer containing 73.7 mole % acrylic acid and 26.3 mole % N-tert-octylacrylamide.

### Example 1

Preparation of the reaction product of SMA with butylamine and (3-aminopropyl)triethoxysilane to give a polymer with 1 mole % silane containing monomer units (Polymer i) is as follows: 10.0 g of dry SMA, with a mole ratio of styrene to maleic anhydride of about 1.0 and M_{w} about 16,000, is suspended in 100 ml of toluene. A solution of 1.72 g of butylamine and 0.21 g of (3-aminopropyl)triethoxysilane in 10 ml of toluene is added at ambient temperature. The mixture is refluxed for 3 hr. The solid product is filtered off, washed, and dried. This gives a polymer containing 53 mole % styrene, 23.9 mole % N-butyl half amide from maleic anhydride, 1 mole % N-(3-triethoxysilyl)propyl half amide from maleic anhydride, and 22.1 mole % maleic anhydride.

### Example 2

Preparation of the reaction product of SMA with butylamine and (3-aminopropyl)triethoxysilane to give a polymer with 3.8 mole % silane containing monomer units (Polymer ii) is as follows: 10.0 g of dry SMA, with a mole ratio of styrene to maleic anhydride of about 1.1 and M_{w} about 16,000, is suspended in 100 ml of toluene. A solution of 1.72 g of butylamine and 0.83 g of (3-aminopropyl)triethoxysilane in 10 ml of toluene is added at ambient temperature. The mixture is refluxed for 3 hr. The solid product is filtered off, washed, and dried. This gives a polymer containing 53 mole % styrene, 23.9 mole % N-butyl half amide from maleic anhydride, 3.8 mole % N-(3-triethoxysilyl)propyl half amide from maleic anhydride, and 19.3 mole % maleic anhydride.

### Example 3

Preparation of the reaction product of SMA with butylamine and (3-aminopropyl)triethoxysilane to give a polymer with 7.6 mole % silane containing monomer units (Polymer iii) is as follows: 10.0 g of dry SMA, with a mole ratio of styrene to maleic anhydride of about 1.1 and M_{w} about 16,000, is suspended in 100 ml of toluene. A solution of 1.72 g of butylamine and 1.66 g of (3-aminopropyl)triethoxysilane in 10 ml of toluene is added at ambient temperature. The mixture is refluxed for 3 hr. The solid product is filtered off, washed, and dried. This gives a polymer containing 53 mole % styrene, 23.9 mole % N-butyl half amide from maleic anhydride, 7.6 mole % N-(3-triethoxysilyl)propyl half amide from maleic anhydride, and 15.5 mole % maleic anhydride.

### Example 4

Preparation of the reaction product of SMA with tallow amine, diethylamine, and (3-aminopropyl)triethoxysilane to give a polymer with 3.8 mole % silane containing monomer units (Polymer iv) is as follows: 100.0 g of dry SMA, with a mole ratio of styrene to maleic anhydride of about 1.1 and M_{w} about 16,000, is suspended in 941.7 g of toluene. A solution of 25.2 g tallow amine, 24.8 g diethylamine, and 8.3 g (3-aminopropyl)triethoxysilane in 38.9 g toluene is added at ambient temperature and the mixture is then refluxed for 30 min. The resulting toluene slurry is cooled to room temperature and then added with mixing to about 700 ml of 2% aqueous caustic. The toluene layer is separated and the residual toluene in the aqueous phase is removed by distillation. The aqueous solution is further purified by ultrafiltration using a 0.2 μm hydrophilic polyethersulfone filter and then freeze dried to obtain the dry polymer. This gives a polymer containing 53 mole % styrene, 3.8 mole % N-(3-triethoxysilyl)propyl half amide from maleic anhydride, 9.4 mole % N-tallow half amide of maleic anhydride, and 33.8 mole % N,N-diethyl half amide of maleic anhydride.

### Example 5

Preparation of the reaction product of SMA with tallow amine, diethylamine, and (3-aminopropyl)triethoxysilane to give a polymer with 7.5 mole % silane containing monomer units (Polymer v) is as follows: 100.0 g of dry SMA, with a mole ratio of styrene to maleic anhydride of about 1.1 and M_{w} about 16,000, is suspended in 941.7 g of toluene. A solution of 20.2 g tallow amine, 23.4 g diethylamine, and 16.7 g (3-aminopropyl)triethoxysilane in 40.2 g toluene is added at ambient temperature and the mixture is then refluxed for 30 min. The resulting toluene slurry is cooled to room temperature and then added with mixing to about 700 ml of 2% aqueous caustic. The toluene layer is separated and the residual toluene in the aqueous phase is removed by distillation. The aqueous solution is further purified by ultrafiltration using a 0.2 μm hydrophilic polyethersulfone filter and then freeze dried to obtain the dry polymer. This gives a polymer containing 53 mole % styrene, 7.5 mole % N-(3-triethoxysilyl)propyl half amide from maleic anhydride, 7.5 mole % N-tallow half amide of maleic anhydride, and 30 mole % N,N-diethyl half amide of maleic anhydride.

### Example 6

Preparation of the reaction product of SMA with tallow amine, diethylamine, and (3-aminopropyl)triethoxysilane to give a polymer with 3.8 mole % silane containing monomer units (Polymer vi) is as follows: 100.0 g of dry SMA, with a mole ratio of styrene to maleic anhydride of about 1.1 and M_{w} about 16,000, is suspended in 941.7 g of toluene. A solution of 10.1 g tallow amine, 28.9 g diethylamine, and 8.3 g (3-aminopropyl)triethoxysilane in 31.3 g toluene is added at ambient temperature and the mixture is then refluxed for 30 min. The resulting toluene slurry is cooled to room temperature and then added with mixing to about 700 ml of 2% aqueous caustic. The toluene layer is separated and the residual toluene in the aqueous phase is removed by distillation. The aqueous solution is further purified by ultrafiltration using a 0.2 μm hydrophilic polyethersulfone filter and then freeze dried to obtain the dry polymer. This gives a polymer containing 53 mole % styrene, 3.8 mole % N-(3-triethoxysilyl)propyl half amide from maleic anhydride, 3.8 mole % N-tallow half amide of maleic anhydride, and 39.4 mole % N,N-diethyl half amide of maleic anhydride.

### Example 7

Preparation of N-(3-triethoxysilyl)propylacrylamide (TESPA) is as follows: 197.4 g of (3-aminopropyl)triethoxysilane and 89.9 g of triethylamine are dissolved in 330 g THF, purged with nitrogen, and cooled to 0° C. With mixing, 83.9 g of acryloyl chloride is added dropwise., and after the addition the mixture is heated to 40° C. for 2 hr. The mixture is cooled to room temperature and the salt filtered out. The resulting solution of TESPA (42% in THF) is used as is without further purification.

### Example 8

Preparation of the tetrapolymer of N-tert-octylacrylamide, acrylic acid, 1-vinyl-2-pyrrolidinone, and TESPA to give a polymer containing 5 mole % silane containing monomer units (Polymer vii) is as follows: 1.89 g of 1-Vinyl-2-pyrrolidinone, 0.66 g acrylic acid, 2.21 g N-tert-octylacrylamide, 1.30 g TESPA (42% in THF), and 0.14 g 2-mercaptoethanol are dissolved in 14 g DMF and 11.64 g dioxane and purged with nitrogen. The mixture is heated to 75° C. and 0.16 g 2,2′-azobis(2,4-dimethylvaleronitrile) in 3 g dioxane is added. After 6 hr at 75° C., the mixture is cooled, giving the desired polymer in solution. The polymer is further purified by precipitation with isopropyl alcohol, washed, and dried. This gives a polymer containing 42.5 mole % 1-vinyl-2-pyrrolidinone, 22.5 mole % acrylic acid, 5 mole % TESPA, and 30 mole % N-tert-octylacrylamide.

### Example 9

Preparation of the copolymer of 1-vinyl-2-pyrrolidinone and TESPA to give a polymer containing 5 mole % silane containing monomer units (Polymer viii) is as follows: 4.69 g of 1-Vinyl-2-pyrrolidinone, 1.44 g TESPA (42% in THF), and 0.14 g 2-mercaptoethanol are dissolved in 12.5 g DMF and 13.07 g dioxane and purged with nitrogen. The mixture is heated to 75° C. and 0.16 g 2,2′-azobis(2,4-dimethylvaleronitrile) in 3 g dioxane is added. After 6 hr at 75° C., the mixture is cooled, giving the desired polymer in solution with 15% concentration. This gives a polymer containing 95 mole % 1-vinyl-2-pyrrolidinone and 5 mole % TESPA.

### Example 10

Preparation of the terpolymer of N-tert-octylacrylamide, acrylic acid, and TESPA to give a polymer containing 5 mole % silane containing monomer units (Polymer ix) is as follows: 2.46 g Acrylic acid, 2.21 g N-tert-octylacrylamide, 1.56 g TESPA (42% in THF), and 0.14 g 2-mercaptoethanol are dissolved in 12.5 g DMF and 12.97 g dioxane and purged with nitrogen. The mixture is heated to 75° C. and 0.16 g 2,2′-azobis(2,4-dimethylvaleronitrile) in 3 g dioxane is added. After 6 hr at 75° C., the mixture is cooled, giving the desired polymer in solution with 15% concentration. This gives a polymer containing 70 mole % acrylic acid, 5 mole % TESPA, and 25 mole % N-tert-octylacrylamide.

### Example 11

Preparation of the reaction product of polyethylene oxide with 3-glycidoxypropyltrimethoxysilane to give a polymer containing 2.2 mole % silane containing monomer units (Polymer x) is as follows: 20.0 g of polyethyleneoxide (Mₙ about 2000) is dissolved in 10.0 g DMSO and purged with nitrogen. To this mixture is added 2.63 g 3-glycidoxypropyltrimethoxysilane, followed by 1.36 g of 45% KOH. The resulting mixture is heated to 80° C. for 1 hr, giving the desired polymer in solution with 65.8% concentration. This gives a polymer containing about 97.8 mole % ethylene oxide and 2.2 mole % 3-glycidoxypropyltrimethoxysilane.

### Example 12

Preparation of the reaction product of poly(ethylene glycol)-block-poly(propylene glycol)-block-poly(ethylene glycol) with 3-glycidoxypropyltrimethoxysilane to give a polymer containing 3.1 mole % silane containing monomer units (Polymer xi) is as follows: 30.0 g of poly(ethylene glycol)-block-poly(propylene glycol)-block-poly(ethylene glycol) (with 50 wt % ethylene oxide and Mₙ about 1900) is mixed with 4.52 g 3-glycidoxypropyltrimethoxysilane under nitrogen. 2.34 g 45% KOH is added and the resulting mixture heated to 80° C. for 1 hr, giving the desired polymer with 92.6% concentration. This gives a polymer containing about 55.1 mole % ethylene oxide, 41.8 mole % propylene oxide, and 3.1 mole % 3-glycidoxypropyltrimethoxysilane.

### Example 13

Preparation of the reaction product of poly(ethylene glycol)-block-poly(propylene glycol)-block-poly(ethylene glycol) with 3-glycidoxypropyltrimethoxysilane to give a polymer containing 3.0 mole % silane containing monomer units (Polymer xii) is as follows: 30.0 g of poly(ethylene glycol)-block-poly(propylene glycol)-block-poly(ethylene glycol) (with 10 wt % ethylene oxide and Mₙ about 2000) is mixed with 4.3 g 3-glycidoxypropyltrimethoxysilane under nitrogen. 2.22 g 45% KOH is added and the resulting mixture heated to 80° C. for 1 hr, giving the desired polymer with 92.9% concentration. This gives a polymer containing about 12.3 mole % ethylene oxide, 84.7 mole % propylene oxide, and 3.0 mole % 3-glycidoxypropyltrimethoxysilane.

### Example 14

Preparation of the reaction product of polyethylenimine with 3-glycidoxypropyltrimethoxysilane to give a polymer containing 0.5 mole % silane containing monomer units (Polymer xiii) is as follows: 25.4 g Polyethylenimine (M_{w} about 25,000) is mixed with 0.7 g 3-glycidoxypropyltrimethoxysilane, and the resulting mixture is heated at 70° C. for 16 hr, giving the desired polymer as a soft friable gel.

### Example 15

Preparation of the reaction product of polyethylenimine with 3-glycidoxypropyltrimethoxysilane to give a polymer containing 1.0 mole % silane containing monomer units (Polymer xiv) is as follows: 25.72 g Polyethylenimine (M_{w} about 25,000) is mixed with 1.43 g 3-glycidoxypropyltrimethoxysilane, and the resulting mixture is heated at 70° C. for 16 hr, giving the desired polymer as a soft friable gel.

### Example 16

Preparation of the reaction product of polyethylenimine with 3-glycidoxypropyltrimethoxysilane to give a polymer containing 2.0 mole % silane containing monomer units (Polymer xv) is as follows: 11.39 g Polyethylenimine (M_{w} about 25,000) is mixed with 1.28 g 3-glycidoxypropyltrimethoxysilane, and the resulting mixture is heated at 70° C. for 16 hr, giving the desired polymer as a soft friable gel.

### Example 17

Preparation of the reaction product of polyethylenimine with 3-glycidoxypropyltrimethoxysilane to give a polymer containing 4.0 mole % silane containing monomer units (Polymer xvi) is as follows: 10.0 g Polyethylenimine (M_{w} about 25,000) is mixed with 2.29 g 3-glycidoxypropyltrimethoxysilane, and the resulting mixture is heated at 70° C. for 16 hr, giving the desired polymer as a soft friable gel.

### Example 18

Preparation of the reaction product of hydroxyethyl cellulose with 3-glycidoxypropyltrimethoxysilane to give a polymer containing a high (˜30 mole %) silane containing monomer units (Polymer xvii) is as follows: 8.0 g dry hydroxyethyl 15 cellulose (molecular weight 24,000-27,000) is mixed with 2.0 g 3-glycidoxypropyltrimethoxysilane in 5 g acetone. The acetone is removed by evaporation and the resulting mixture heated at 100° C. for 16 hr, giving the desired polymer.

TABLE 1
Summary of Polymers Used in Scale Inhibition Testing

| | | | Mole % |
|---|---|---|---|
| Example | Polymer | Composition | Silane* |
| Comparative | Comparative A | Reaction product of SMA with | 0 |
| A | | butylamine | |
| Comparative | Comparative B | Reaction product of SMA with | 0 |
| B | | tallow amine and diethylamine | |
| Comparative | Comparative C | Copolymer of N-tert-octylamide | 0 |
| C | | and acrylic acid | |
| | Comparative D | Polyethylenimine (M_{w} ˜25,000) | 0 |
| | | obtained from Aldrich | |
| | Comparative E | Polyvinylpyrrolidone (M_{w} | 0 |
| | | ˜10,000)from Aldrich | |
| 1 | i | Reaction product of SMA with | 1 |
| | | butylamine and (3- | |
| | | aminopropyl)triethoxysilane | |
| 2 | ii | reaction product of SMA with | 3.8 |
| | | butylamine and (3- | |
| | | aminopropyl)triethoxysilane | |
| 3 | iii | reaction product of SMA with | 7.6 |
| | | butylamine and (3- | |
| | | aminopropyl)triethoxysilane | |
| 4 | iv | Reaction product of SMA with | 3.8 |
| | | tallow amine, diethylamine, and | |
| | | (3-aminopropyl)triethoxysilane | |
| 5 | v | reaction product of SMA with | 7.5 |
| | | tallow amine, diethylamine, and | |
| | | (3-aminopropyl)triethoxysilane | |
| 6 | vi | reaction product of SMA with | 3.8 |
| | | tallow amine, diethylamine, and | |
| | | (3-aminopropyl)triethoxysilane | |
| 7 | vii | tetrapolymer of N-tert- | 5 |
| | | octylacrylamide, acrylic acid, | |
| | | 1-vinyl-2-pyrrolidinone, and | |
| | | TESPA | |
| 8 | viii | copolymer of 1-vinyl-2- | 5 |
| | | pyrrolidinone and TESPA | |
| 9 | ix | terpolymer of N-tert- | 5 |
| | | octylacrylamide, acrylic acid, | |
| | | and TESPA | |
| 10 | x | reaction product of | 2.2 |
| | | polyethylene oxide with 3- | |
| | | glycidoxypropyltrimethoxysilane | |
| 11 | xi | reaction product of | 3.1 |
| | | poly(ethylene glycol)-block- | |
| | | poly(propylene glycol)-block- | |
| | | poly(ethylene glycol) with 3- | |
| | | glycidoxypropyltrimethoxysilane | |
| 12 | xii | reaction product of | 3.0 |
| | | poly(ethylene glycol)-block- | |
| | | poly(propylene glycol)-block- | |
| | | poly(ethylene glycol) with 3- | |
| | | glycidoxypropyltrimethoxysilane | |
| 13 | xiii | reaction product of | 0.5 |
| | | polyethylenimine with 3- | |
| | | glycidoxypropyltrimethoxysilane | |
| 14 | xiv | reaction product of | 1 |
| | | polyethylenimine with 3- | |
| | | glycidoxypropyltrimethoxysilane | |
| 15 | xv | reaction product of | 2 |
| | | polyethylenimine with 3- | |
| | | glycidoxypropyltrimethoxysilane | |
| 16 | xvi | the reaction product of | 4 |
| | | polyethylenimine with 3- | |
| | | glycidoxypropyltrimethoxysilane | |
| 17 | xvii | the reaction product of | ˜30 |
| | | hydroxyethyl cellulose with 3- | |
| | | glycidoxypropyltrimethoxysilane | |

*Mole % of monomer units in the polymer containing the silane functional group.

### Example 19

Test Procedure

A synthetic high level nuclear waste liquor is made by adding sodium carbonate, sodium sulfate, sodium hydroxide, sodium aluminate solution (made by digesting alumina trihydrate in caustic), sodium silicate, sodium nitrate, and sodium nitrite to deionized water. The final composition of the liquor is shown in Table 2

TABLE 2

| Species | Concentration (mole/l) |
|---|---|
| NaOH | 4.5 |
| NaNO₃ | 1.0 |
| NaNO₂ | 1.0 |
| Na₂CO₃ | 0.25 |
| Na₂SO₄ | 0.25 |
| Alumina Trihydrate | 0.5 |
| SiO₂ | 0.01 |

All of the polymer samples are dissolved in 2% aqueous NaOH prior to addition to the nuclear waste liquor, hydrolyzing any anhydride and trialkoxylsilane groups that have not previously been reacted, transforming the trialkoxylsilane groups into silanol groups or the sodium salts. Into a 125 ml polyethylene bottle, are placed the scale reducing additive (if used) as a 0.5% solution in 2% aqueous NaOH for the lower doses and for the higher doses a 3% solution is used. 120 ml of the above stock synthetic high level nuclear waste solution is then added to the bottle with mixing. The sealed bottle is heated with agitation at 102° C. for 18±2 hours. Up to 24 such tests (bottles) are done at one time. At the end of the 18 hours, the bottles are opened and the solution is filtered (0.45 μm filter). Considerable aluminosilicate scale is observed to form as loose aluminosilicate in the liquor (which may have initially formed on the polyethylene surfaces). In the examples below, the weight of scale formed in the test is expressed as a percentage of the average weight of scale that formed on two comparative blank tests (i.e. no additive used) that are part of the same set of tests.

Using the test procedure outlined above, a series of SMA type polymers reacted with butylamine and containing varying amounts of silane are examined for aluminosilicate scale inhibition activity and the results are reported in Table 3.

TABLE 3

| | | | Total Scale Formed, |
|---|---|---|---|
| Polymer | Mole % Silane | Dosage, mg/l | % vs. Blank |
| Comparative A | 0 | 10 | 104.4 |
| Comparative A | 0 | 50 | 103.9 |
| i | 1 | 10 | 69.4 |
| i | 1 | 50 | 72.6 |
| ii | 3.8 | 10 | 63.3 |
| ii | 3.8 | 50 | 37.1 |
| iii | 7.6 | 10 | 5.2 |
| iii | 7.6 | 50 | 1.0 |

### Example 20

Using the test procedure as outlined in Example 19, a series of SMA polymers reacted with tallow amine and diethylamine and containing varying amounts of silane are examined for scale inhibition activity and the results are reported in Table 4.

TABLE 4

| | | | Total Scale Formed, |
|---|---|---|---|
| Polymer | Mole % Silane | Dosage, mg/l | % vs. Blank |
| Comparative B | 0 | 10 | 87.4 |
| Comparative B | 0 | 50 | 95.8 |
| iv | 3.8 | 10 | 59.2 |
| iv | 3.8 | 50 | 54.9 |
| v | 7.5 | 10 | 2.8 |
| v | 7.5 | 50 | 0 |
| vi | 3.8 | 10 | 49.6 |
| vi | 3.8 | 50 | 66.8 |

### Example 21

Using the test procedure as outlined in Example 19, a series of polymers made with the silane containing monomer TESPA are examined for scale inhibition activity and the results are reported in Table 5.

TABLE 5

| | | | Total Scale Formed, |
|---|---|---|---|
| Polymer | Mole % Silane | Dosage, mg/l | % vs. Blank |
| Comparative C | 0 | 10 | 102.8 |
| Comparative C | 0 | 50 | 104.2 |
| Comparative E | 0 | 10 | 93.5 |
| Comparative E | 0 | 50 | 101.2 |
| vii | 5 | 10 | 3.1 |
| vii | 5 | 50 | 2.9 |
| viii | 5 | 10 | 1.6 |
| viii | 5 | 50 | 2.7 |
| ix | 5 | 10 | 2.7 |
| ix | 5 | 50 | 1.1 |

### Example 22

Using the test procedure as outlined in Example 19, a series of polyether type polymers containing varying amounts of silane are examined for scale inhibition activity and the results are reported in Table 6.

TABLE 6

| | | | |
|---|---|---|---|
| | | | Total Scale Formed, |
| Polymer | Mole % Silane | Dosage, mg/l | % vs. Blank |

| | | | |
|---|---|---|---|
| x | 2.2 | 10 | 68.0 |
| x | 2.2 | 50 | 6.2 |
| x | 2.2 | 300 | 2.2 |
| xi | 3.1 | 10 | 21.0 |
| xi | 3.1 | 50 | 1.0 |
| xi | 3.1 | 300 | 1.9 |
| xii | 3.0 | 10 | 23.3 |
| xii | 3.0 | 50 | 6.2 |
| xii | 3.0 | 300 | 0.7 |

### Example 23

Using the test procedure as outlined in Example 19, a series of polyethylenimine type polymers containing varying amounts of silane are examined for scale inhibition activity and the results are reported in Table 7.

TABLE 7

| | | | Total Scale Formed, |
|---|---|---|---|
| Polymer | Mole % Silane | Dosage, mg/l | % vs. Blank |
| Comparative D | 0 | 10 | 102.0 |
| Comparative D | 0 | 50 | 105.5 |
| Comparative D | 0 | 300 | 112.8 |
| xiii | 0.5 | 10 | 43.3 |
| xiii | 0.5 | 50 | 1.6 |
| xiii | 0.5 | 300 | 0 |
| xiv | 1 | 10 | 4.2 |
| xiv | 1 | 50 | 0 |
| xiv | 1 | 300 | 0.1 |
| xv | 2 | 10 | 0 |
| xv | 2 | 50 | 0 |
| xv | 2 | 300 | 0 |
| xvi | 4 | 10 | 0 |
| xvi | 4 | 50 | 0 |
| xvi | 4 | 300 | 0 |

### Example 24

Using the test procedure as outlined in Example 19, a hydroxyethyl cellulose derivative containing silane is examined for scale inhibition activity and the results are reported in Table 8.

TABLE 8

| | | | Total Scale Formed, |
|---|---|---|---|
| Polymer | Mole % Silane | Dosage, mg/l | % vs. Blank |
| xvii | ˜30 | 10 | 17.5 |
| xvii | ˜30 | 50 | 3.0 |
| xvii | ˜30 | 300 | 16.9 |

What is claimed is:

1. A process for the reduction of formation of aluminosilicate containing scale in nuclear waste streams comprising the step of:
adding to the nuclear waste process stream an aluminosilicate containing scale inhibiting amount of a polymer having pendant thereto a group or an end group containing formula I:
—Si(OR″)₃ Formula I
where R″═H, C1-C10 alkyl, aryl, Na, K or NH₄.

2. A method of claim 1 in which the polymer contains at least 0.5 mole % of a group of the formula I
—Si(OR″)₃ Formula I
where R″═H, C1-C10 alkyl, aryl, Na, K or NH₄.

3. The process for the reduction of aluminosilicate containing scale in a nuclear waste process according to claim 1, wherein the group comprises a group according to formula II:
-G-R—X—R′—Si(OR″)₃ Formula II
where G=no group, NH, NR″ or O;
R=no group, C═O, O, C1-C10 alkyl, or aryl;
X=no group, NR, O, NH, amide, urethane, or urea;
R′=no group, O, C1-C10 alkyl, or aryl; and
R″═H, C1-C3 alkyl, aryl, Na, K or NH₄.

4. The process for the reduction of aluminosilicate containing scale in a nuclear waste process according to claim 1, wherein the polymer comprises at least one nitrogen to which the group is pendant thereto.

5. The process for the reduction of aluminosilicate containing scale in a nuclear waste process according to claim 4, wherein the polymer comprises a polymer according to formula III: 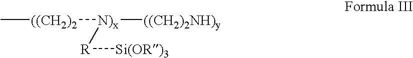
where x=0.1-100%, y=99.9-0%; and
R=no group, C1-C10 alkyl, aryl, or —COX—R′—,
where X═O or NH and R′=no group, C1-C10 alkyl or aryl; and
R″═H, C1-C3 alkyl, aryl, Na, K or NH₄.

6. The process for the reduction of aluminosilicate containing scale in a nuclear waste process according to claim 5, wherein R═C2-C6 alkyl.

7. The process for the reduction of aluminosilicate containing scale in a nuclear waste process according to claim 6, wherein the polymer is a polymer according to the formula IV: 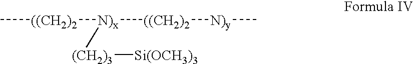
where x=0.5-20%, y=99.5-80%.

8. A process for the reduction of aluminosilicate containing scale in a Nuclear waste process according to claim 1, in which the polymer is derived from an unsaturated polymerizable monomer containing the group —Si(OR″)₃
where R″═H, C1-C10 alkyl, aryl, Na, K or NH₄ and is optionally copolymerized with one or more polymerizable monomer(s).

9. The process for the reduction of aluminosilicate containing scale in a nuclear waste process according to claim 8, in which the polymer is a homopolymer or copolymer derived from an unsaturated monomer of formula V or VI: 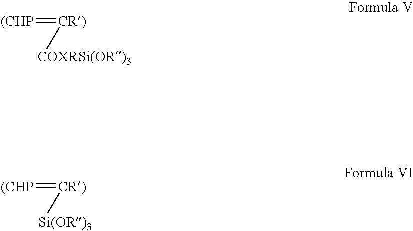
where P═H, C1-C3 alkyl, —CO2R″, —CONHR
R═C1-C10 alkyl, aryl,
R′═H, C1-3 alkyl, or aryl
X═O, NH, or NR
R″═H, C1-C3 alkyl, aryl, Na, K or NH₄.

10. The process for the reduction of aluminosilicate containing scale in a nuclear waste process according to claim 9, in which the polymer is derived from monomers of formulae V or VI and one or more polymerizable monomers selected from the group, vinylpyrrolidone, (meth)acrylamide, N-substituted acrylamides, (meth)acrylic acid and it's salts or esters and maleimides.

11. The process for the reduction of aluminosilicate containing scale in a nuclear waste process according to claim 10, in which the polymer is a copolymers one or more comonomers of formulae V or VI and one or more comonomers selected from the group consisting of vinylpyrrolidone, acrylamide, N-substituted acrylamides containing from 4-20 carbon atoms, (meth)acrylic acid and it's salts.

12. The process for the reduction of aluminosilicate containing scale in a nuclear waste process according to claim 11, in which the polymer is a copolymers one or more comonomers of formulae V or VI and one or more comonomers selected from the group consisting of vinylpyrrolidone, N-octylacrylamide, acrylic acid and it's salts.

13. The process for the reduction of aluminosilicate containing scale in a nuclear waste process according to claim 12, in which the polymer is a homo- or copolymers of one or more comonomers of formulae VII: 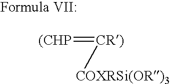
where P═H
R═—CH₂CH₂CH₂—
R′═H
X═NH
R″═H, C1-C3 alkyl, aryl, Na, K or NH₄.

14. The process for the reduction of aluminosilicate containing scale in a nuclear waste process according to claim 1, wherein the polymer is a polymer according to formula VIII: 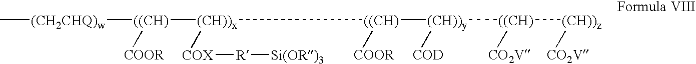
where w=1-99.9 %, x=0.1-50%, y=0-50%, z=0-50%; and Q=C1-C10 alkyl, aryl, amide, acrylate, ether, COXR where X═O or NH and R═H, Na, K, NH₄, C1-C10 alkyl or aryl, or any other substituent; X═NH, NP where P═C1-C3 alkyl or aryl, or O; R′═C1-10 alkyl, or aryl; V″═H, C1-C3 alkyl, aryl, Na, K or NH₄ or forms an anhydride ring ; R″═H, C1-C3 alkyl, aryl, Na, K or NH₄; and D=NR1₂ or OR1 wherein R1=H, C1-C20 alkyl, C1-C20 alkenyl or aryl, with the proviso that all R, R″, V″ and R1 groups do not have to be the same, is used.

15. The process for the reduction of aluminosilicate containing scale in a nuclear waste process according to claim 14, wherein the polymer is a polymer according to the formula XI: 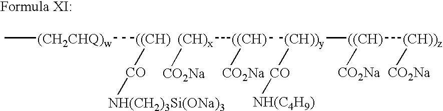
where w=1-99.9%, x=0.1-50%, y=0-50%, z=0-50%; and Q is phenyl is used.

16. The process for the reduction of aluminosilicate containing scale in a nuclear waste process according to claim 14, the polymer is a polymer according to the formula X: 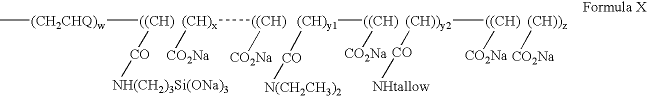
where w=1-99.9%, x=0.1-50%, y1+Y2=0-50%, y1 and y2=0-50% z=0-50%; and Q is phenyl is used.

17. The process for the reduction of aluminosilicate containing scale in a nuclear waste process according to claim 1, wherein the polymer is a polymer according to the formula XI:
A-O—(CH₂CH₂O)ₓ(CH₂CH(CH₃)O)_{y}(CH₂CH₂O)_{z}—O—B Formula XI
where x=5-100%, y and z=0-100% and at least one A and/or B unit is a group containing the the group —Si(OR″)₃, where R″═H, C1-C3 alkyl, aryl, Na, K or NH₄, is used.

18. The process for the reduction of aluminosilicate containing scale in a nuclear waste process according to claim 17, wherein x=100%, y and z=0% is used.

19. The process for the reduction of aluminosilicate containing scale in a nuclear waste process according to claim 17, wherein x=5-50%, y=5-95% and z=0-50% is used.

20. The process for the reduction of aluminosilicate containing scale in a nuclear waste process according to claim 1, wherein the polymer is a polysaccharide having pendant thereto a group or an end group containing formula I:
—Si(OR″)₃ Formula I
where R″═H, C1-C10 alkyl, aryl, Na, K or NH₄.

21. The process for the reduction of aluminosilicate containing scale in a nuclear waste process according to claim 20 in which the polysaccharide is a cellulose derivative.

22. The process for the reduction of aluminosilicate containing scale in a nuclear waste process according to claim 21 in which the polysaccharide is hydroxyethylcellulose derivative.

23. The process for the reduction of aluminosilicate containing scale in a nuclear waste process according to claim 22 in which the polysaccharide is a hydroxyethylcellulose derivative and is reacted with 3-glycidoxypropyltrimethoxysilane.
